(19) United States
(12) Patent Application Publication
(10) Pub. No.: US 2015/0219779 A1
(43) Pub. Date: Aug. 6, 2015

(54) QUALITY CONTROL OF 3D HORIZON AUTO-TRACKING IN SEISMIC VOLUME

(71) Applicant: Schlumberger Technology Corporation, Houston, TX (US)

(72) Inventors: Zhenghan Deng, Katy, TX (US); Bruce Cornish, Houston, TX (US); Jay Vogt, Houston, TX (US)

(21) Appl. No.: 14/554,926

(22) Filed: Nov. 26, 2014

Related U.S. Application Data
(60) Provisional application No. 61/935,145, filed on Feb. 3, 2014.

(51) Int. Cl. G01V 1/34; G01V 1/30

(52) U.S. Cl. CPC G01V 1/345; G01V 1/30

(57) ABSTRACT

Seismic interpretation includes obtaining a seismic volume of a subterranean formation of a field. Through the seismic volume based on a similarity criterion of seismic values in the set of seismic traces, an estimated horizon is generated based on a selected seed while maintaining tracking data tracking the generating of the estimated horizon. A first selection of a selected point in the estimated horizon is received, and, from the tracking data, an ancestral path from the selected point to the selected seed is extracted. A subset of the set of seismic traces is selected based on the subset comprising points along the ancestral path, and displayed, within a graphic window on a physical display, the subset of the set of seismic traces.

### CROSS-REFERENCE TO RELATED APPLICATIONS

This application claims priority under 35 U.S.C. §119(e) to U.S. Provisional Patent Application Serial Number 61/935,145, filed on Feb. 3, 2014 and entitled, “QUALITY CONTROL OF 3D HORIZON AUTO-TRACKING IN SEISMIC VOLUME.” U.S. Provisional Patent Application Ser. No. 61/935,145 is incorporated herein by reference in its entirety.

### BACKGROUND

Operations, such as surveying, drilling, wireline testing, completions, production, planning and field analysis, may be performed to locate and gather valuable downhole fluids. Surveys are often performed using acquisition methodologies, such as seismic scanners or surveyors to generate maps of underground formations. These formations are often analyzed to determine the presence of subterranean assets, such as valuable fluids or minerals, or to determine if the formations have characteristics suitable for storing fluids. The subterranean assets are not limited to hydrocarbon such as oil, throughout this document, the terms “oilfield” and “oilfield operation” may be used interchangeably with the terms “field” and “field operation” to refer to a field having any types of valuable fluids or minerals and field operations relating to any of such subterranean assets.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to seismic interpretation. A seismic volume of a subterranean formation of a field is obtained. The seismic volume includes a set of seismic traces of the subterranean formation. Through the seismic volume based on a similarity criterion of seismic values in the set of seismic traces, an estimated horizon is generated based on a selected seed while maintaining tracking data tracking the generating of the estimated horizon. A first selection of a selected point in the estimated horizon is received, and, from the tracking data, an ancestral path from the selected point to the selected seed is extracted. The ancestral path includes a sequence of derived points that are recursively derived from the selected seed based on the similarity criterion. A subset of the set of seismic traces is selected based on the subset comprising points along the ancestral path, and displayed, within a graphic window on a physical display, the subset of the set of seismic traces. The subset of the set of seismic traces is annotated with the ancestral path.

### BRIEF DESCRIPTION OF DRAWINGS

The appended drawings illustrate several embodiments of quality control of 3D horizon auto-tracking in seismic volume and are not to be considered limiting of its scope, for quality control of 3D horizon auto-tracking in seismic volume may admit to other equally effective embodiments.

FIG. 1 is a schematic view, partially in cross-section, of a field having a plurality of data acquisition tools positioned at various locations along the field for collecting data from the subterranean formation, in which embodiments of quality control of 3D horizon auto-tracking in seismic volume may be implemented.

FIG. 2 shows a system in which one or more embodiments of quality control of 3D horizon auto-tracking in seismic volume may be implemented.

FIGS. 3.1 and 3.2 show example methods for quality control of 3D horizon auto-tracking in seismic volume in accordance with one or more embodiments.

FIGS. 4.1, 4.2, 4.3, 4.4, and 4.5 show an example for quality control of 3D horizon auto-tracking in seismic volume in accordance with one or more embodiments.

FIGS. 5.1, 5.2, and 5.3 show example workflows for quality control of 3D horizon auto-tracking in seismic volume in accordance with one or more embodiments.

FIG. 6 shows a computer system in which one or more embodiments of quality control of 3D horizon auto-tracking in seismic volume may be implemented.

### DETAILED DESCRIPTION

Embodiments are shown in the above-identified drawings and described below. In describing the embodiments, like or identical reference numerals are used to identify common or similar elements. The drawings are not necessarily to scale and certain features and certain views of the drawings may be shown exaggerated in scale or in schematic in the interest of clarity and conciseness.

During the field operations, data may be collected for analysis and/or monitoring of the operations. Such data may include, for instance, information regarding subterranean formations, equipment, and historical and/or other data. Data concerning the subterranean formation may be collected using a variety of sources. Such formation data may be static or dynamic. Static data relates to, for instance, formation structure and geological stratigraphy that define geological structures of the subterranean formation. Dynamic data relates to, for instance, fluids flowing through the geologic structures of the subterranean formation over time. Such static and/or dynamic data may be collected to learn more about the formations and the valuable assets contained therein.

Collecting data may be performed using seismic surveying. Seismic surveying may be performed by imparting energy to the earth at one or more source locations, for example, by way of controlled explosion, mechanical input etc. Return energy is then measured at surface receiver locations at varying distances and azimuths from the source location. The travel time of energy from source to receiver, via reflections and refractions from interfaces of subsurface strata, indicates the depth and orientation of such strata. Seismic data, as collected via the receiver, within a volume of interest may be referred to as seismic volume. A seismic volume may be displayed as seismic images based on different sampling resolutions and viewing orientations as well as subject to various different seismic amplitude processing techniques to enhance or highlight seismic reflection patterns.

The data may be used to predict downhole conditions and make decisions concerning field operations. Such decisions may involve well planning, well targeting, well completions, operating levels, production rates and other operations and/or operating parameters. A large number of variables and large quantities of data to consider in analyzing field operations may exist. Because of the large number of variables and large quantities of data, modeling the behavior of the field operation to determine the desired course of action may be useful. Various aspects of field operations, such as geological structures, downhole reservoirs, wellbores, surface facilities, as well as other portions of the field operation, may be modeled. The modeling may be used to perform field operations. Further, during the ongoing operations, the operating parameters may be adjusted as field conditions change and new information is received.

Seismic images may indirectly show the distribution of material deposited over large areas. The spatial and/or temporal variability of stacking patterns or sequences, observed in seismic images relates to depositional environments and post-depositional processes, such as erosion and tectonic activity. In other words, reflection patterns in the seismic images link depositional environments and vertical stacking order to sequence of deposition in the subterranean formation. During seismic interpretation, relative timing of the seismic image reflection patterns enables the geological history of the subsurface to be deciphered and leads to the estimation of probable sedimentary characteristics. In this manner, a potential hydrocarbon reservoir may be identified and analyzed based on interpretation and analysis of seismic reflection data. However, performing seismic data interpretation over large seismic volumes may be a daunting task, particularly if done manually.

One aspect of seismic interpretation is picking subsurface horizons, or simply referred to as “picking”. In other words picking involves selecting points in the seismic images of the subsurface formations that correspond to a subsurface horizon. While interpreting seismic lines (that is, a two-dimensional vertical slice or a “vertical seismic section”) may be accomplished by viewing and picking one line at a time, the picking may be performed by clicking the cursor on a few selected points along a horizon and letting the machine pick the rest of the points on that line. Automated picking may increase both productivity and accuracy over manual picking. In an automatic system for tracking a bedding plane (i.e., a horizon) in a horizontal slice of three-dimensional (3D) data, a user selects or “inputs” at least one “seed point”, which is then “expanded” in four directions within the 3D data until the expanded point reached the boundaries of a user specified zone.

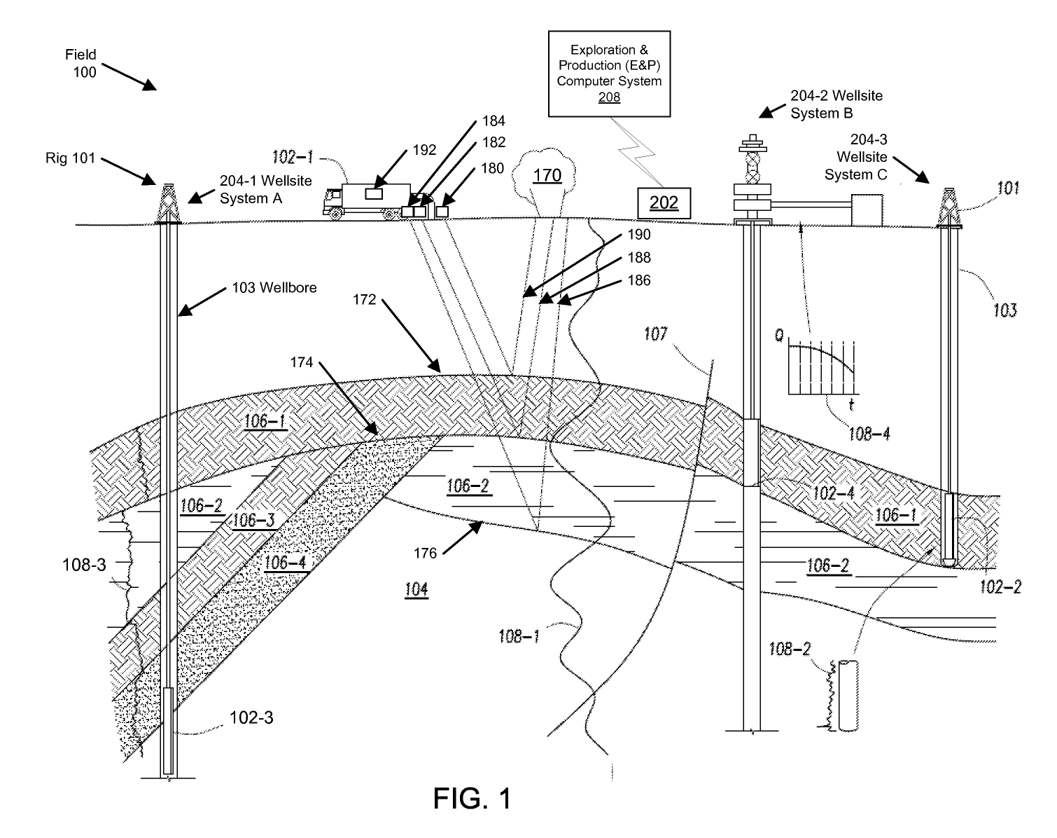

FIG. 1 depicts a schematic view, partially in cross section, of a field (100) in which one or more embodiments of quality control of 3D horizon auto-tracking in seismic volume may be implemented. In one or more embodiments, one or more of the modules and elements shown in FIG. 1 may be omitted, repeated, and/or substituted. Accordingly, embodiments of quality control of three dimensional (3D) horizon auto-tracking in seismic volume should not be considered limited to the specific arrangements of modules shown in FIG. 1.

As shown in FIG. 1, the field (100) includes the subterranean formation (104), data acquisition tools (102-1), (102-2), (102-3), and (102-4), wellsite system A (204-1), wellsite system B (204-2), wellsite system C (204-3), a surface unit (202), and an exploration and production (E&P) computer system (208). The subterranean formation (104) includes several geological structures, such as a sandstone layer (106-1), a limestone layer (106-2), a shale layer (106-3), a sand layer (106-4), and a fault line (107).

In one or more embodiments, data acquisition tools (102-1), (102-2), (102-3), and (102-4) are positioned at various locations along the field (100) for collecting data of the subterranean formation (104), referred to as survey operations. In particular, these data acquisition tools are adapted to measure the subterranean formation (104) and detect the characteristics of the geological structures of the subterranean formation (104). For example, data plots (108-1), (108-2), (108-3), and (108-4) are depicted along the field (100) to demonstrate the data generated by these data acquisition tools. Specifically, the static data plot (108-1) is a seismic two-way response time. Static plot (108-2) is core sample data measured from a core sample of the formation (104). Static data plot (108-3) is a logging trace, referred to as a well log. Production decline curve or graph (108-4) is a dynamic data plot of the fluid flow rate over time. Other data may also be collected, such as historical data, user inputs, economic information, and/or other measurement data and other parameters of interest.

To capture the seismic two-way response time in the static data plot (108-1), the data acquisition tools (102-1) may be a seismic truck that is adapted to measure properties of the subterranean formation based on sound vibrations. One such sound vibration (e.g., 186, 188, 190) generated by a source (170) reflects off a plurality of horizons (e.g., 172, 174, 176) in the subterranean formation (104). Each of the sound vibrations (e.g., 186, 188, 190) are received by one or more sensors (e.g., 180, 182, 184), such as geophone-receivers, situated on the earth's surface. The geophones produce electrical output signals, which may be transmitted, for example, as input data to a computer (192) on the seismic truck (102-1). Responsive to the input data, the computer (192) may generate a seismic data output, such as the seismic two-way response time.

Further as shown in FIG. 1, the wellsite system A (204-1), wellsite system B (204-2), and wellsite system C (204-3) are associated with a rig, a wellbore, and other wellsite equipment configured to perform wellbore operations, such as logging, drilling, fracturing, production, or other applicable operations. For example, the wellsite systems (204-1), (204-2), (204-3) is associated with a rig (101), a wellbore (103), and drilling equipment to perform drilling operation. Similarly, the wellsite system B (204-2) and wellsite system C (204-3) are associated with respective rigs, wellbores, and other wellsite equipment, such as production equipment and logging equipment to perform production operations and logging operations, respectively. Generally, survey operations and wellbore operations are referred to as field operations of the field (100). In addition, data acquisition tools and wellsite equipment are referred to as field operation equipment. These field operations may be performed as directed by a surface unit (202). For example, the field operation equipment may be controlled by a field operation control signal sent from the surface unit (202).

In one or more embodiments, the surface unit (202) is operatively coupled to the data acquisition tools (102-1), (102-2), (102-3), (102-4), and/or the wellsite systems (204-1), (204-2), (204-3). In particular, the surface unit (202) is configured to send commands to the data acquisition tools (102-1), (102-2), (102-3), (102-4), and/or the wellsite systems (204-1), (204-2), (204-3) and to receive data therefrom. In one or more embodiments, the surface unit (202) may be located at the wellsite systems (204-1), (204-2), (204-3) and/or remote locations. The surface unit (202) may be provided with computer facilities for receiving, storing, processing, and/or analyzing data from the data acquisition tools (102-1), (102-2), (102-3), (102-4), the wellsite systems (204-1), (204-2), (204-3), and/or other part of the field (100). The surface unit (202) may also be provided with or functionally for actuating mechanisms at the field (100). The surface unit (202) may then send command signals to the field (100) in response to data received, for example to control and/or optimize various field operations described above.

In one or more embodiments, the surface unit (202) is communicatively coupled to an E&P computer system (208). In one or more embodiments, the data received by the surface unit (202) may be sent to the E&P computer system (208) for further analysis. Generally, the E&P computer system (208) is configured to analyze, model, control, optimize, or perform management tasks of the aforementioned field operations based on the data provided from the surface unit (202). In one or more embodiments, the E&P computer system (208) is provided with functionality for manipulating and analyzing the data, such as performing seismic interpretation or borehole resistivity image log interpretation to identify geological surfaces in the subterranean formation (104) or performing simulation, planning, and optimization of production operations of the wellsite systems (204-1), (204-2), (204-3). In one or more embodiments, the result generated by the E&P computer system (208) may be displayed for user viewing using a two-dimensional (2D) display, 3D display, or other suitable displays. Although the surface unit (202) is shown as separate from the E&P computer system (208) in FIG. 1, in other examples, the surface unit (202) and the E&P computer system (208) may also be combined.

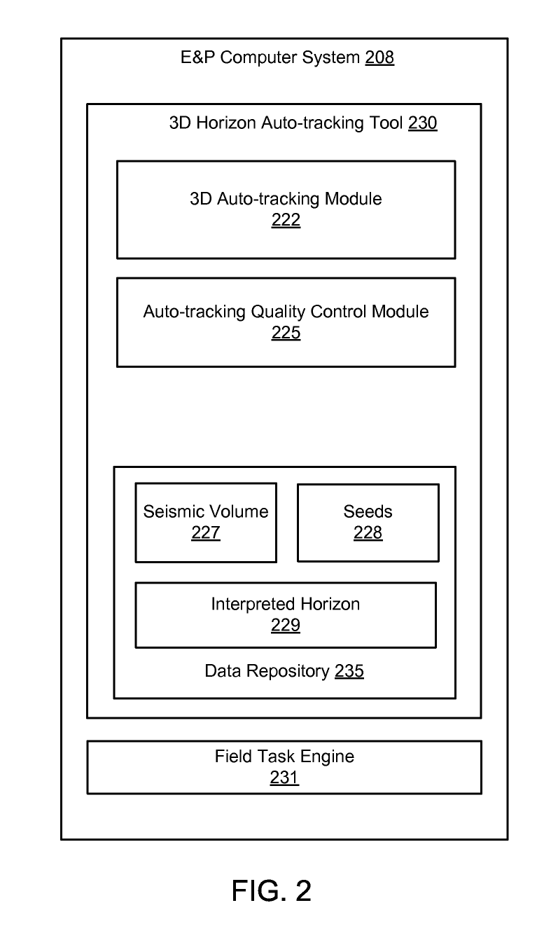

FIG. 2 shows more details of the E&P computer system (208) in which one or more embodiments of quality control of 3D horizon auto-tracking in seismic volume may be implemented. In one or more embodiments, one or more of the modules and elements shown in FIG. 2 may be omitted, repeated, and/or substituted. Accordingly, embodiments of quality control of 3D horizon auto-tracking in seismic volume should not be considered limited to the specific arrangements of modules shown in FIG. 2.

As shown in FIG. 2, the E&P computer system (208) may include a 3D horizon auto-tracking tool (230), a data repository (235) for storing intermediate data and resultant outputs of the 3D horizon auto-tracking tool (230), and a field task engine (231) for performing various tasks of the field operation. In one or more embodiments, the data repository (235) may include a disk drive storage device, a semiconductor storage device, other suitable computer data storage device, or combinations thereof. In one or more embodiments, content stored in the data repository (235) may be a data file, a linked list, a data sequence, a database, a graphical representation, or any other suitable data structure.

In one or more embodiments, the seismic traces (e.g., data plot (108-1) depicted in FIG. 1 above are provided to the E&P computer system (208) and stored in the data repository (235) as the seismic volume (227). In one or more embodiments, the seismic volume (227) may be displayed as a three-dimensional (3D) volume to a user performing seismic interpretation, who is referred to as a seismic interpretation user. The top of the displayed 3D volume represents the surface location of individual seismic traces.

Within the 3D volume, the seismic traces may be represented as vertical lines of seismic amplitude versus time or distance along the Z-axis of the 3D volume. In other words, a 3D volume may be, at least in part, composed of seismic traces. A seismic trace represents the response of the elastic wave field to velocity and density contrasts across interfaces of layers of rock or sediments as energy travels from a source through the subsurface to a receiver or receiver array. Specifically, each individual trace is a representation of seismic amplitude versus time of an acoustic reflection from geological structures in the subterranean formation. For example, the seismic amplitude may be represented as color or shading pattern, while the time progression may be represented by the vertical line through the seismic volume. Other representations of seismic traces may be used without departing from the scope of one or more embodiments. A seismic trace in a sequence along the X direction is referred to as a “line” or “in-line” in seismic interpretation. A seismic trace in a sequence along the Y direction is referred to as a “cross-line.” A “horizon slice” is a slice (i.e., either a flat surface or a non-planar surface) in the 3D volume that is identified by the seismic interpretation user as corresponding to a horizon (e.g., one of the horizons (172, 174, 176)) in the subterranean formation (104) depicted in FIG. 1 above.

In one or more embodiments, the 3D horizon auto-tracking tool (230) is configured to facilitate seismic interpretation to identify a horizon slice from the seismic volume (227) as an interpreted horizon (e.g., the interpreted horizon (229)). Specifically, the interpreted horizon, also referred to as an estimated horizon, is a 2D surface in the seismic volume (227) that estimates locations of the horizon in the subterranean formation. As shown in FIG. 2, the 3D horizon auto-tracking tool (230) includes the 3D auto-tracking module (222) and the auto-tracking quality control module (225). One aspect of seismic interpretation is picking subsurface horizons, which may be referred to as “picking”. The 3D auto-tracking module (222) may, in some embodiments, provide the ability for the seismic interpretation user to pick 3D data more quickly and effectively to identify the horizon slice.

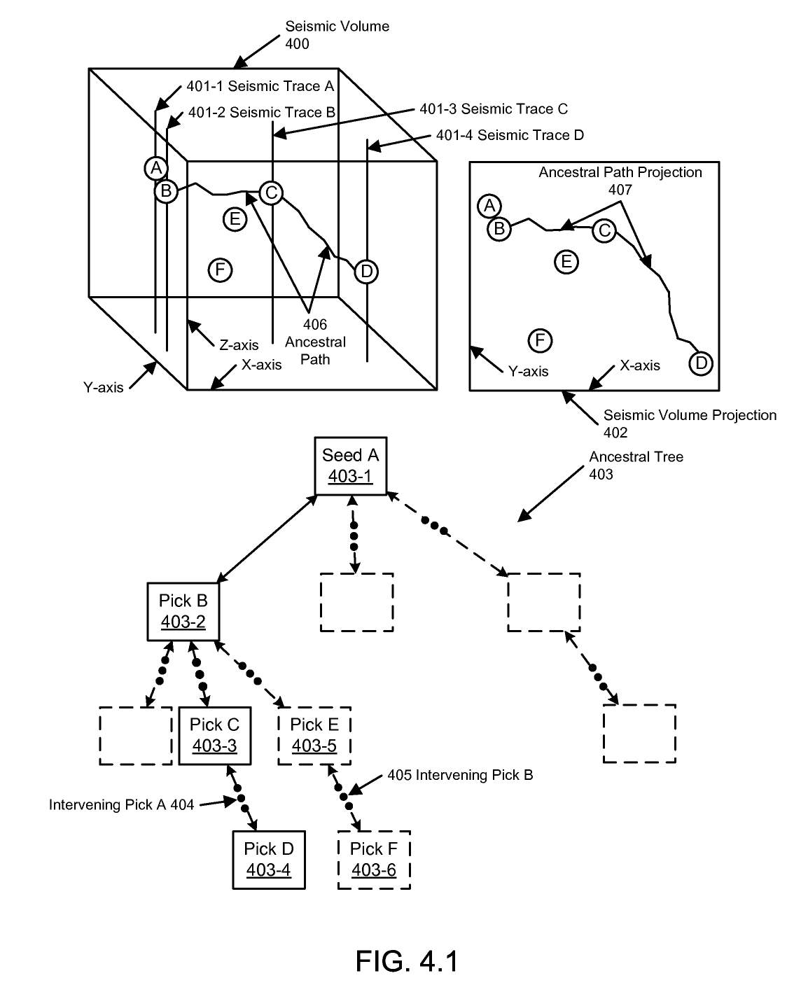

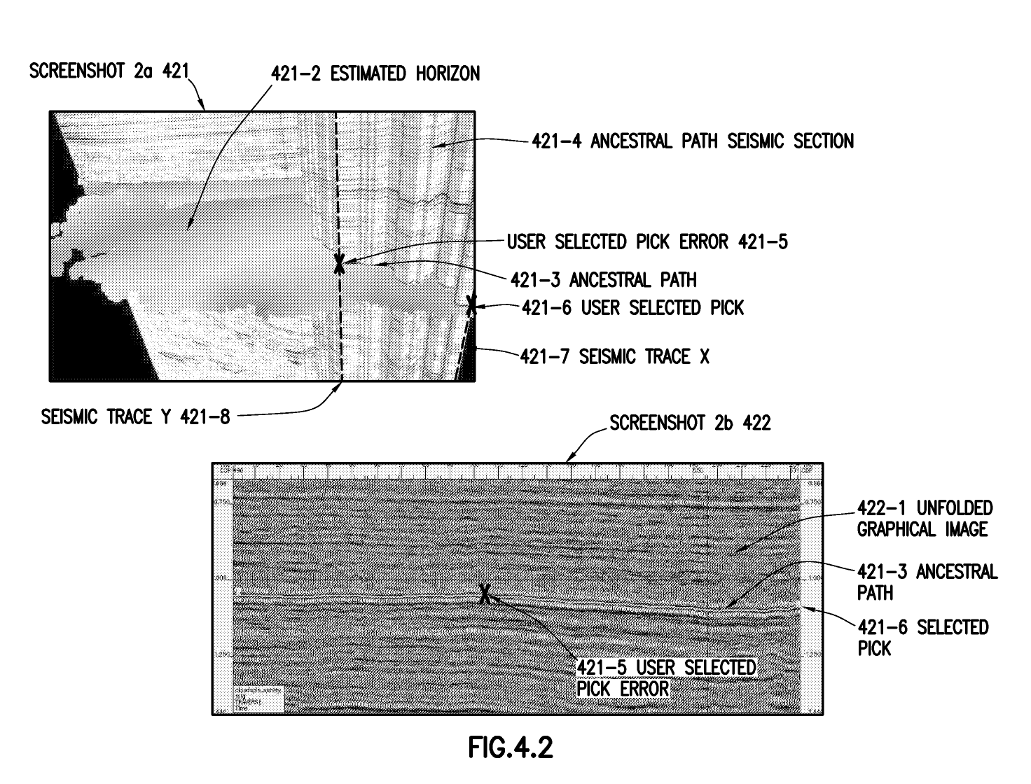

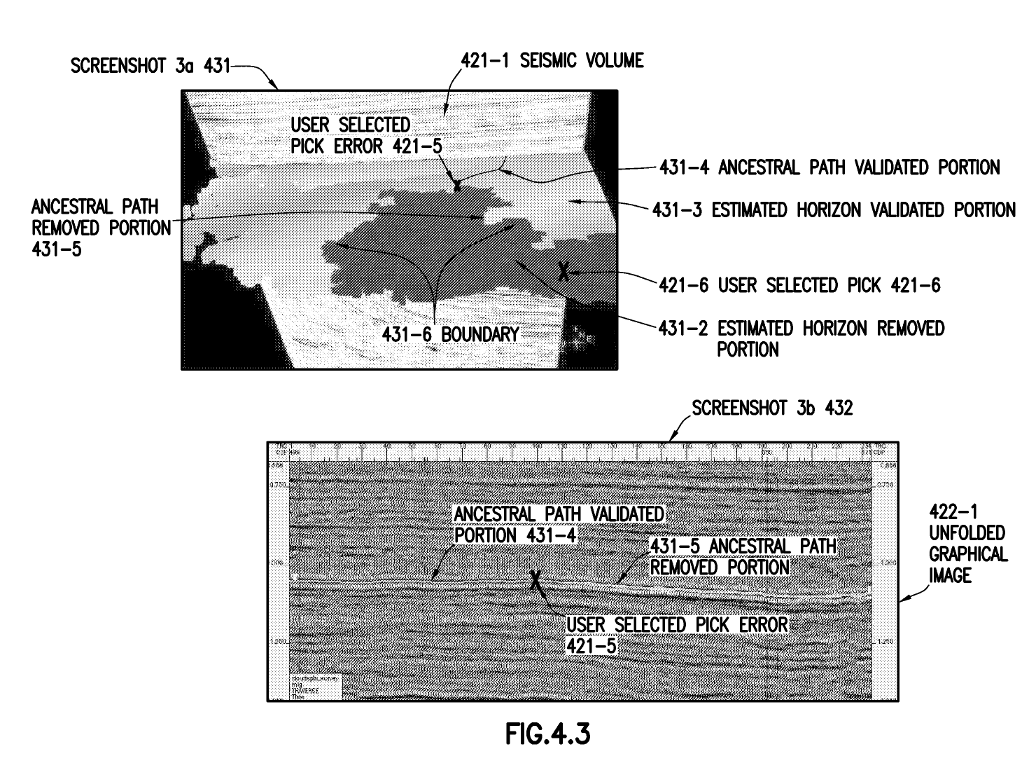

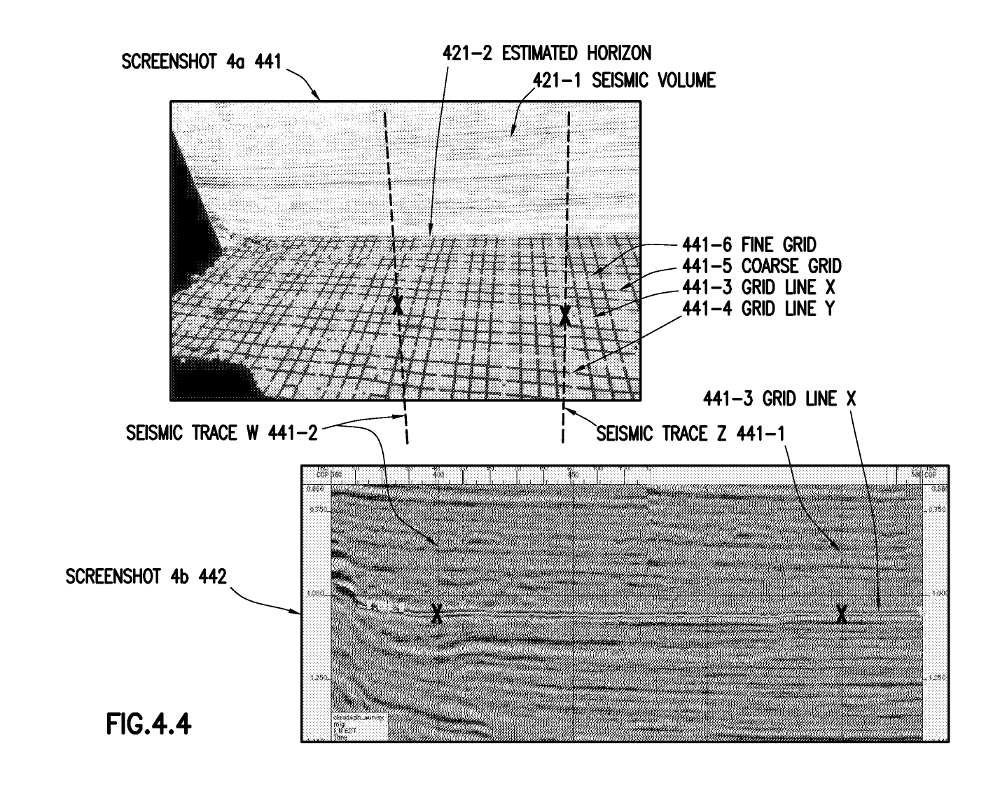

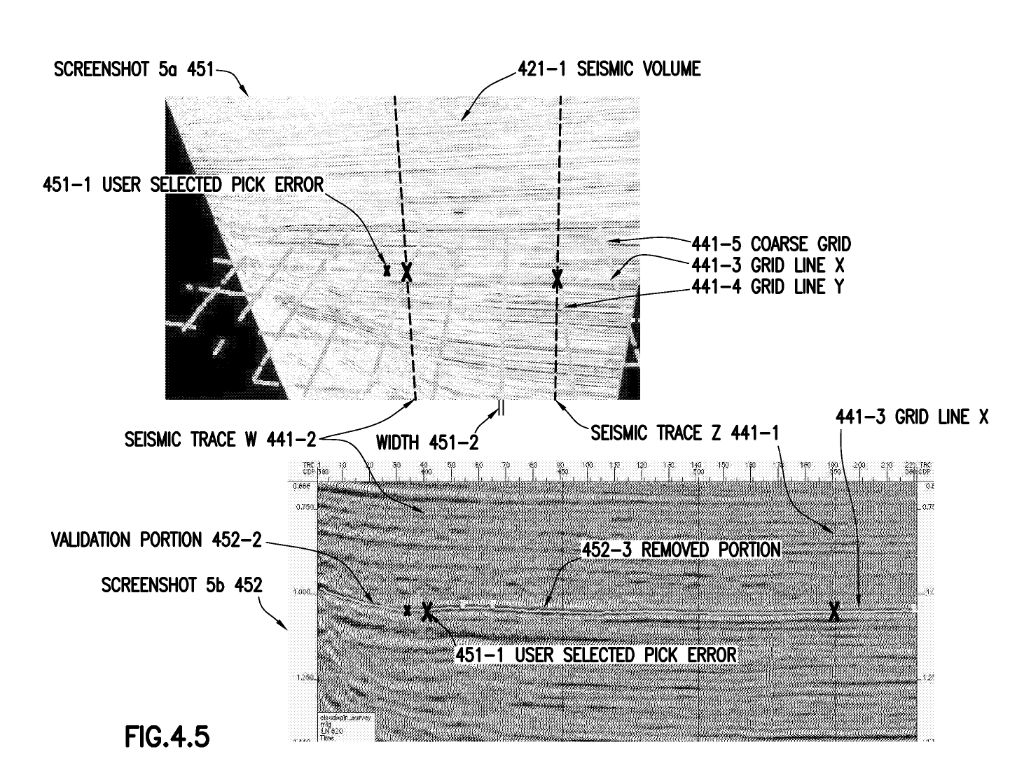

In one or more embodiments, the seismic interpretation user selects at least one seed point in a seismic trace of the 3D volume. In other words, the seismic interpretation user considers the selected seed point to approximate where the seismic trace intersects the target horizon being identified. Using a pre-determined auto-tracking algorithm, the 3D auto-tracking module (222) expands the user selected seed point in four directions along potentially varying depths within the 3D volume until reaching the boundaries of a user specified zone. Specifically, neighboring un-interpreted seismic traces near each seed point may be evaluated based on certain criteria (referred to as auto-tracking criteria), such as signal similarity within a certain time/depth window. A candidate pick is selected at the time/depth location of neighbor traces if the auto-tracking criteria are satisfied. In other words, the time/depth location of neighbor traces is picked to approximate where the neighbor traces intersect with the target horizon being identified. Once a neighboring seismic trace has been successfully interpreted (auto-tracked), the candidate pick on the neighboring seismic trace may be used as a new seed point (referred to as a derivative seed point) for subsequent traces. The auto-tracking algorithm may continue to process the nearest neighbor traces until the traces in the user specified zone are either interpreted or rejected. In one or more embodiments, the user selected seed point(s) and the derivative seed point(s) are stored in the data repository (235) as the seeds (228). The resultant interpreted seismic traces form the interpreted horizon (229). An example of picking a subsurface horizon is depicted in FIG. 4.1 below.

In one or more embodiments, the auto-tracking quality control module (225) provides validation of automated horizon results generated by the 3D auto-tracking module (222). The term “ancestral relationship” may refer to the order and geometry in which candidate picks are selected after successfully passing the auto-tracking criteria applied to original seeds and derivative seeds. In other words, when a derivative seed is used to select a next candidate pick, the derivative seed is in ancestral relationship with the candidate pick as the derivative seed becomes an ancestor of the next candidate pick and any subsequent picks from the next candidate pick.

In one or more embodiments, the validation results of the auto-tracking quality control module (225) are a set of unique paths through the 3D volume that connect each interpreted point back to an original seed point via the interpreted point's ancestral map. The unique paths may be referred to as an ancestral path. Each path may trace the optimum correlation through the 3D volume from original to final auto tracked value. Visually, each ancestral path may appear to the seismic interpretation user as a meandering stream from original to final auto-tracked value endpoints. The ancestral path may be used to evaluate the accuracy of the 3D auto-tracking module (222) by viewing any available seismic data in either 2D or 3D views. Changes and refinements made to the ancestral paths are then incorporated with previous inputs to become new seeds for subsequent auto-tracking operations. An example of the ancestral path is depicted in FIG. 4.1 below.

In one or more embodiments, the 3D horizon auto-tracking tool (230) is configured to provide to the seismic interpretation user one or more displays (e.g., 2D display, 3D display, etc.) during the seismic interpretation. For example, the displays may include the seismic volume (227), the seeds (228), and the interpreted horizon (229).

In one or more embodiments, E&P computer system (208) includes the field task engine (231) that is configured to generate a field operation control signal based at least on the interpreted horizon (229). As noted above, the field operation equipment depicted in FIG. 1 above may be controlled by the field operation control signal. For example, the field operation control signal may be used to control drilling equipment, an actuator, a fluid valve, or other electrical and/or mechanical devices disposed about the field (100) depicted in FIG. 1 above.

The E&P computer system (208) may include one or more system computers, which may be implemented as a server or any conventional computing system. However, those skilled in the art, having benefit of this disclosure, will appreciate that implementations of various technologies described herein may be practiced in other computer system configurations, including hypertext transfer protocol (HTTP) servers, hand-held devices, multiprocessor systems, microprocessor-based or programmable consumer electronics, network personal computers, minicomputers, mainframe computers, and the like.

While specific components are depicted and/or described for use in the units and/or modules of the E&P computer system (208) and the 3D horizon auto-tracking tool (230), a variety of components with various functions may be used to provide the formatting, processing, utility and coordination functions for the E&P computer system (208) and the 3D horizon auto-tracking tool (230). The components may have combined functionalities and may be implemented as software, hardware, firmware, or combinations thereof.

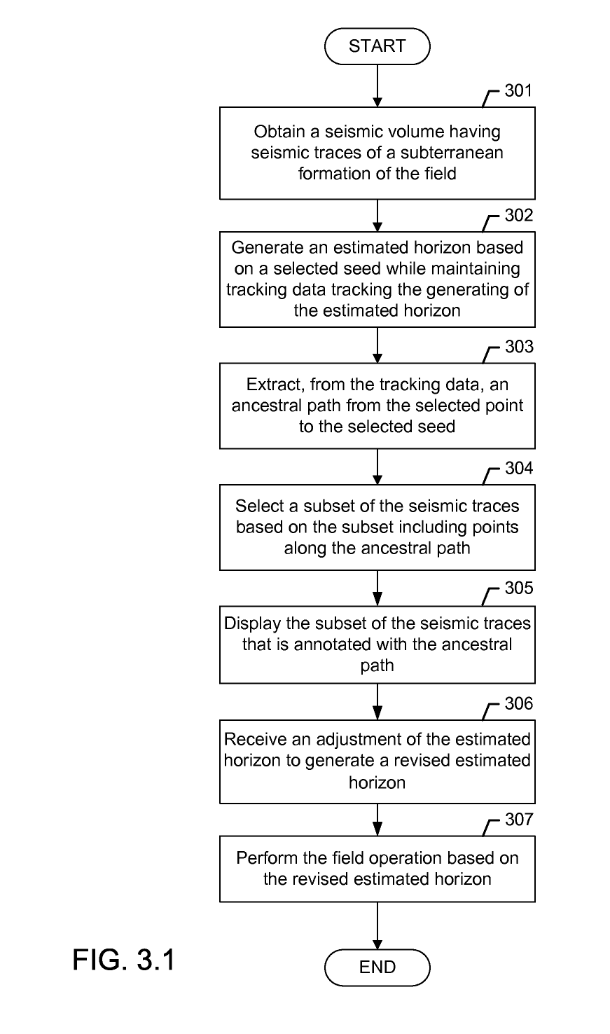

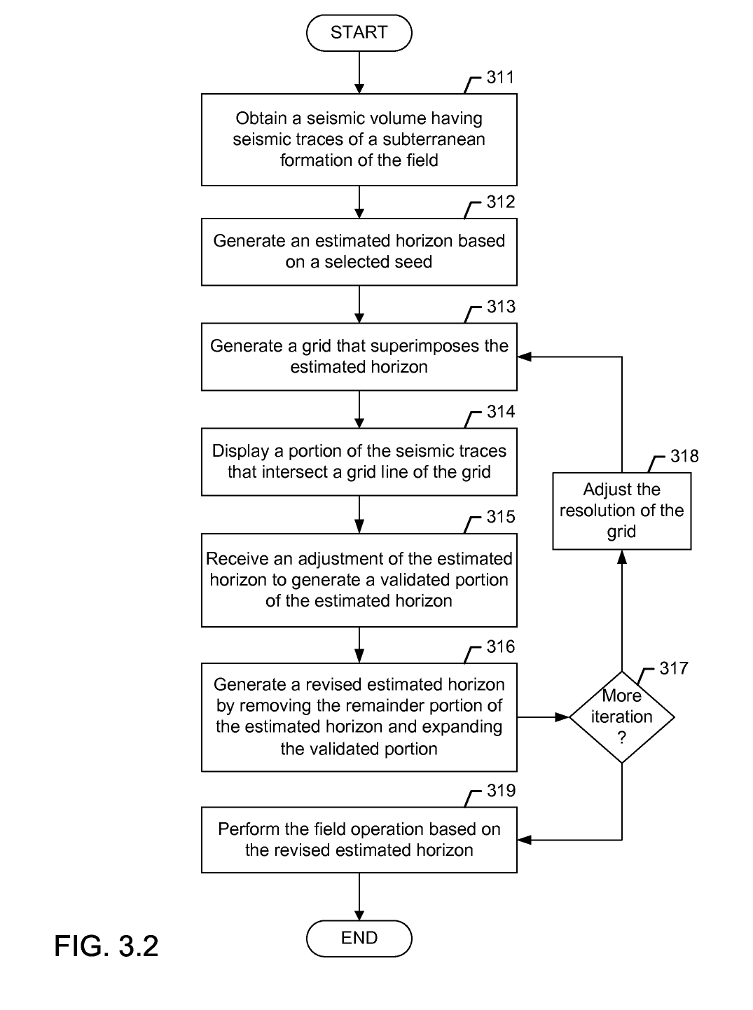

FIG. 3.1 shows an example method for quality control of 3D horizon auto-tracking in seismic volume in accordance with one or more embodiments. For example, the method shown in FIG. 3.1 may be practiced using the E&P computer system (208) and the 3D horizon auto-tracking tool (230) described in reference to FIG. 2 above for the field (100) described in reference to FIG. 1 above. In one or more embodiments, one or more of the elements shown in FIG. 3.1 may be omitted, repeated, and/or performed in a different order. Accordingly, embodiments of quality control of 3D horizon auto-tracking in seismic volume should not be considered limited to the specific arrangements of elements shown in FIG. 3.1.

Initially in Element 301, a seismic volume is obtained that includes a set of seismic traces of a subterranean formation of a field. For example, the set of seismic traces may be obtained from the subterranean formation using the data acquisition tool, as shown in FIG. 1 above. In the example, in some embodiments, the equipment shown in FIG. 1 and/or other equipment may perform seismic surveys as discussed above to obtain seismic traces, which is stored in a seismic volume. In some embodiments, the seismic volume may be obtained from a data repository.

In Element 302, an estimated horizon is generated through the seismic volume using an auto-tracking algorithm that is based on a similarity criterion of seismic values in the set of seismic traces. In particular, a user selects one or more user selected seeds. The 3D auto-tracking module auto-tracks to select neighboring point to be candidate picks based on the auto-tracking criteria. Thus, the candidate picks are assumed to be part of an estimated horizon. The process may iteratively repeat from the candidate picks to select additional neighboring picks. In one or more embodiments, the estimated horizon is generated based on a selected seed while maintaining tracking data tracking the generating of the estimated horizon. In other words, as candidate picks are selected, tracking data is maintained. Specifically, the tracking data describes ancestral relationships among the user selected seed and auto-tracked picks generated using the auto-tracking algorithm. In one or more embodiments, the ancestral relationship is described based on an ancestral tree having ancestral paths.

In one or more embodiments, the estimated horizon is generated using the 3D auto-tracking module (222) depicted in FIG. 2 above. An example of the auto-tracking algorithm and using the auto-tracking algorithm to identify the estimated horizon from the seismic volume is described in reference to FIG. 4.1 below.

In Element 303, an ancestral path is extracted from the tracking data. Specifically, the ancestral path identifies intervening picks from a user selected point on the estimated horizon to the selected seed from which the estimated horizon was generated. In one or more embodiment, the ancestral path includes a sequence of derived points (i.e., auto-tracked picks) that are recursively derived from the selected seed based on the auto-tracking criterion. For example, a seismic interpretation user may select the user selected point in a study area of the estimated horizon to verify the validity of the auto-tracking results in the study area. Extracting the ancestral path may be performed by receiving the user selected point from the user. For example, the user may select the point from a display of the estimated horizon in the 3D seismic volume. When the user selects the user selected point, the tracking data is accessed to determine each precedent derivative seed in the ancestral path from that point that ultimately resulted in the user selected point being a part of the estimated horizon. An example of the ancestral path is described in reference to FIG. 4.1 below.

In Element 304, a subset of the set of seismic traces is selected based on the subset including points along the ancestral path. In Element 305, the subset of the set of seismic traces is displayed within a graphic window on a physical display. In one or more embodiments, the subset of the set of seismic traces is annotated with the ancestral path. As noted above, the ancestral path may be a meandering path zigzagged across the estimated horizon. Accordingly, the subset of the set of seismic traces follows the meandering path and forms a folded graphical image, referred to as the ancestral path seismic section. In one or more embodiments, displaying the subset of the set of seismic traces starts with converting the folded graphical image into an unfolded graphical image on a 2D plane (i.e., a flat 2D surface). The conversion may be performed based on a spatial mapping algorithm that maps a folded coordinate system on a folded 2D surface onto a Euclidean coordinate system on the unfolded 2D plane. In other words, the folded graphical image is “stretched” flat onto the 2D surface. Accordingly, the unfolded graphical image on a 2D surface is displayed to facilitate viewing by the seismic interpretation user.

An example of the selecting and displaying the subset of seismic traces is described in reference to FIG. 4.2 below.

In Element 306, an adjustment of the estimated horizon is received to generate a revised estimated horizon. In one or more embodiments, the adjustment includes an auto-tracked pick selected by the seismic interpretation user from the ancestral path. For example, the seismic interpretation user may select this auto-tracked pick while viewing the unfolded graphical image to verify the validity of the auto-tracking results in the study area. Specifically, this auto-tracked pick is selected by the seismic interpretation user as an error of the estimated horizon. For example, the seismic interpretation user may deem the auto-tracked pick to be an error and not reflect an actual horizon.

In one or more embodiments, the adjustment further includes an indication from the seismic interpretation user to remove a portion of the ancestral path downstream to the selected auto-tracked pick in an opposite direction from the user selected seed. In other words, any portion of the estimated horizon that is selected based on the auto-tracked pick and, therefore, has the selected auto-tracked pick in the portion's ancestral path, is removed. In addition, the seismic interpretation user may also indicate to remove an incorrect portion of the estimated horizon that is derived from the removed portion of the ancestral path. The remaining portion of the estimated horizon is referred to as the validated portion of the estimated horizon. In one or more embodiments, the validated portion of the estimated horizon is expanded into a revised estimated horizon using the auto-tracking algorithm. For example, a boundary of the validated portion of the estimated horizon is created by removing the incorrect portion of the estimated horizon. Accordingly, points along the boundary may be used as derived seeds by the auto-tracking algorithm to expand the validated portion of the estimated horizon.

In one or more embodiments, Elements 303, 304, 305, and 306 are performed using the auto-tracking quality control module (225) depicted in FIG. 2 above. An example of adjusting the estimated horizon to generate the revised estimated horizon is described in reference to FIGS. 4.3 and 5.1-5.2 below.

In Element 307, a field operation is performed based at least on the estimated horizon and/or the revised estimated horizon. For example, the field operation may be performed using the field task engine (231) of the E&P computer system (208) depicted in FIGS. 1 and 2 above. The field operation may be a physical transformation to change the equipment at the field, adjust the state (e.g., from open to close for valves, speed and/direction of drilling equipment, amount of fluid injected, etc.) of the equipment at the field. The field operation may be performed in a computer system to adjust simulation parameters or other parameters that indirectly affect physical operations.

FIG. 3.2 shows an example method for quality control of 3D horizon auto-tracking in seismic volume in accordance with one or more embodiments. For example, the method shown in FIG. 3.2 may be practiced using the E&P computer system (208) and the 3D horizon auto-tracking tool (230) described in reference to FIG. 2 above for the field (100) described in reference to FIG. 1 above. In one or more embodiments, one or more of the elements shown in FIG. 3.2 may be omitted, repeated, and/or performed in a different order. Accordingly, embodiments of quality control of 3D horizon auto-tracking in seismic volume should not be considered limited to the specific arrangements of elements shown in FIG. 3.2.

Initially in Element 311, a seismic volume is obtained that includes a set of seismic traces of a subterranean formation of a field. For example, the set of seismic traces may be obtained from the subterranean formation using the data acquisition tool, as shown in FIG. 1 above.

In Element 312, an estimated horizon is generated through the seismic volume using an auto-tracking algorithm that is based on a similarity criterion of seismic values in the set of seismic traces. In one or more embodiments, the estimated horizon is generated based on a selected seed. In one or more embodiments, the estimated horizon is generated using the 3D auto-tracking module (222) depicted in FIG. 2 above. An example of the auto-tracking algorithm and using the auto-tracking algorithm to identify the estimated horizon from the seismic volume is described in reference to FIG. 4.1 below.

In Element 313, a grid is generated that superimposes the estimated horizon. In one or more embodiments, the grid includes grid lines along the X direction and Y direction within the seismic volume. In one or more embodiments, the resolution of the grid is specified by a seismic interpretation user. In one or more embodiments, the width of each grid line is specified by the seismic interpretation user.

In Element 314, a portion of the set of seismic traces that intersect the grid lines of the grid is displayed. Specifically, the seismic amplitudes are displayed for points within the width of each grid line.

In Element 315, in response to presenting the limited portion of the estimated horizon, an adjustment of the estimated horizon is received from the seismic interpretation user to generate a revised estimated horizon. In one or more embodiments, the adjustment includes an auto-tracking error that is identified within the limited portion of the seismic horizon by the seismic interpretation user. For example, the seismic interpretation user may inspect the entirety of the limited portion of the estimated horizon to locate the auto-tracking error. In another example, the seismic interpretation user may inspect the limited portion of the estimated horizon on a grid line by grid line basis to locate the auto-tracking error. In one or more embodiments, the portion of the grid line downstream from the auto-tracking error is marked for removal, while the portion of the grid line up stream from the auto-tracking error is marked as validated. For example, the removal portion and the validated portion may be determined based on the ancestral tree of the estimated horizon, as shown in FIG. 4.1 above.

In Element 316, a revised estimated horizon is generated by removing the portion of the grid line marked for removal. In addition, any point on the estimated horizon that does not belong to the grid is also removed from the estimated horizon. In other words, the validated portion of each grid line of the grid is exclusively retained in the revised estimated horizon.

In Element 317, a determination is made as to whether additional iteration of estimated horizon validation is to be performed. If the determination is positive, i.e., an additional iteration is to be performed, the method proceeds to Element 318. If the determination is negative, i.e., no additional iteration is to be performed, the method proceeds to Element 319, where a field operation is performed based on the estimated revised horizon.

In Element 318, the resolution of the grid is adjusted before returning to Element 313 for the next iteration of validating the estimated horizon. For example, the resolution of the grid may be increased based on input from the seismic interpretation user.

An example of adjusting the estimated horizon to generate the revised estimated horizon is described in reference to FIGS. 4.4, 4.5, and 5.3 below.

In Element 319, a field operation is performed based at least on the estimated horizon and/or the revised estimated horizon. For example, the field operation may be performed using the field task engine (231) of the E&P computer system (208) depicted in FIGS. 1 and 2 above. The field operation may be a physical transformation to change the equipment at the field, adjust the state (e.g., from open to close for valves, speed and/direction of drilling equipment, amount of fluid injected, etc.) of the equipment at the field. The field operation may be performed in a computer system to adjust simulation parameters or other parameters that indirectly affect physical operations.

FIGS. 4.1, 4.2, 4.3, 4.4, and 4.5 show an example for quality control of 3D horizon auto-tracking in seismic volume in accordance with one or more embodiments. In one or more embodiments, the example shown in FIGS. 4.1-4.5 are based on the system and method described in reference to FIGS. 2 and 3.1-3.2 above and is applicable to the field (100) depicted in FIG. 1 above. As noted above, auto-tracking technique during seismic interpretation generate a set of auto-tracking results where each auto-tracked interpretation point stores information on the parent point from which the auto-tracked interpretation point was created. When the user selects an auto-tracked interpretation point to validate the auto-tracking results, the auto-tracking quality control (QC) module selects the set of parent points that trace back to the original input seed for the selected auto-tracked interpretation point. This ancestral path is displayed as a wandering (e.g., wiggly or crooked) line that is viewable in both the 3D volume and 2D section views.

FIG. 4.1 shows an example of an auto-tracked horizon result in a schematic representation. As shown in FIG. 4.1, seismic interpretation is performed for the seismic volume (400) represented schematically based on the X, Y, and Z axes. For example, each of the seismic trace A (401-1), seismic trace B (401-2), seismic trace C (401-3), and seismic trace D (401-4) represents a plot of seismic amplitude versus depth. In particular, the depth is represented by a location on the seismic trace along the Z-axis, while the color representation of the seismic amplitude is omitted for clarity. Within the seismic volume (400), point A represents the location of a user selected seed on the seismic trace A (401-1). Points B, C, D, E, and F represent locations of auto-tracked picks that are automatically and recursively generated based on the user selected seed using the auto-tracking algorithm. For example, the point B on the seismic trace B (401-2) presents the immediate child of the user selected seed (i.e., point A). In other words, the auto-tracking algorithm selects (i.e., picks) the point B, within a section of the seismic trace B (401-2) adjacent to the point A, as having the closest seismic amplitude comparing to the seismic amplitude of the point A. As noted above, the auto-tracked picks are used as derived seeds by the auto-tracking algorithm for recursively generating additional auto-tracked picks to complete the interpreted horizon. For example, the interpreted horizon encompassing the points A, B, C, D, E, F, and additional picks may be a non-planar 2D surface based on different Z coordinates of these points. A projection of the points A, B, C, D, E, and F onto the X-Y plane is shown in the seismic volume projection (402) to illustrate different X coordinates and different Y coordinates of these points.

Further, as shown in FIG. 4.1, the ancestral tree (403) shows the ancestral relationships among the user selected seed and the auto-tracked picks represented by the points A, B, C, D, E, and F. Specifically, the seed A (403-1), pick B (403-2), pick C (403-3), pick D (403-4), pick E (403-5), and pick F (403-6) correspond to the points A, B, C, D, E, and F, respectively. In particular, the branch of the ancestral tree (403) extending from the seed A (403-1) through the pick B (403-2), pick C (403-3), pick D (403-4), and intervening picks (e.g., intervening pick A (404)) corresponds to the ancestral path (406) that exists between point D and point A within the seismic volume (400). Similarly, another branch of the ancestral tree (403) extending from the seed A (403-1) through the pick B (403-2), pick E (403-5), pick F (403-6), and intervening picks (e.g., intervening pick B (405)) corresponds to another ancestral path that exists between point F and point A within the seismic volume (400). A projection of the ancestral path (406) onto the X-Y plane is shown in the seismic volume projection (402) as the ancestral path projection (407).

As noted above, for any auto-tracked horizon point within the seismic volume (400), a unique ancestral path leading to the point A (i.e., the user selected seed) exists. In addition, if the pick B (403-2) is identified by the seismic interpretation user as an incorrect pick during the quality control process, the pick B (403-2) and picks derived from the pick B (403-2) are removed from the interpreted horizon. For example, the pick C (403-3), pick D (403-4), pick E (403-5), pick F (403-6), intervening picks (e.g., intervening pick A (404), intervening pick B (405)), as well as any other pick derived from them are removed.

FIG. 4.2 shows a screenshot 2a (421) of a seismic volume (421-1) corresponding to the schematic representation of the seismic volume (400) shown in FIG. 4.1 above. Specifically, the screenshot 2a (421) shows an ancestral path seismic section (421-4) (i.e., the aforementioned folded graphical image) along an ancestral path (421-3) meandering through an estimated horizon (421-1) in a 3D perspective view. In other words, the ancestral path seismic section (421-4) intersects the estimated horizon (421-1) along the ancestral path (421-3). In particular, the ancestral path (421-3) is extracted from an ancestral tree of the estimated horizon (421-2) based on the user selected pick (421-6). As noted above, the ancestral path (421-3) starts from a user selected seed (not shown, hidden behind the ancestral path seismic section (421-4)) and ends at the user selected pick (421-6). For example, the ancestral path (421-3) may correspond to a portion of the ancestral path (406) shown in FIG. 4.1 above. In particular, the user selected pick (421-6) and the seismic trace X (421-7) may correspond to the pick C (403-3) and the seismic trace C (401-3), respectively shown in FIG. 4.1 above. In addition, the estimated horizon (421-2) includes points that correspond to the point A, point B, point C, point D, point E, and point F shown in FIG. 4.1 above.

Further as shown in FIG. 4.2, the screenshot 2b (422) shows the ancestral path seismic section (421-4) in a 2D view (i.e., the aforementioned unfolded graphical image). The vertical direction of the 2D view corresponds to the direction of seismic traces. The folded graphical image of the ancestral path seismic section (421-4) is “stretched” flat onto a 2D surface as the unfolded graphical image (422-1). Similarly, the ancestral path (421-3) is stretched flat onto the 2D surface. The ancestral path (421-3) is highlighted in the unfolded graphical image (422-1) to facilitate viewing and editing by the seismic interpretation user. The folded graphical image of the ancestral path seismic section (421-4) and the unfolded graphical image (422-1) enable a unique validation and editing environment in a display window where the seismic interpretation user is most comfortable interpreting. For example, upon viewing the estimated horizon (421-2), the seismic interpretation user may specify, on the folded graphical image or on the unfolded graphical image (422-1), an error (i.e., user selected pick error (421-5)). For example, the user selected pick error (421-5) and the seismic trace Y (421-8) may correspond to the pick B (403-2) and the seismic trace B (401-2), respectively, shown in FIG. 4.1 above. Once selected, the seismic interpretation user may adjust the estimated horizon (421-2), as shown in FIG. 4.3 below.

FIG. 4.3 shows an example of how to use the ancestral path seismic section to quickly locate auto-tracked horizon picks to be edited using the auto-tracking QC module. Specifically, FIG. 4.3 shows a screenshot 3a (431) of the same seismic volume (421-1) and the same user selected pick error (421-5) shown in FIG. 4.2 above. In the screenshot 3a (431), the ancestral path seismic section (421-4) is omitted for clarity. Based on an input from the seismic interpretation user to adjust the estimated horizon (421-2), the portion (i.e., ancestral path removed portion (431-5)) of the ancestral path (421-3) downstream to the user selected pick error (421-5) is selected for removal. The remaining portion of the ancestral path (421-3) is referred to as the ancestral path validated portion (431-4). In addition, the portion (i.e., estimated horizon removed portion (431-2)) of the estimated horizon (421-2) derived from the user selected pick error (421-5) during the auto-tracking process is also selected for removal. The remaining portion of the estimated horizon (421-2) is referred to as the estimated horizon validated portion (431-3). Corresponding to the schematic view shown in FIG. 4.1 above, the ancestral path removed portion (431-5) may include the pick B (403-2), pick C (403-3), and pick D (403-4), while the estimated horizon removed portion (431-2) may further includes the pick D (403-4) and pick F (403-6).

The estimated horizon validated portion (431-3) and the estimated horizon removed portion (431-2) are separated by the by the boundary (431-6). As noted above, the estimated horizon validated portion (431-3) may be expanded into a revised estimated horizon (not shown) using the auto-tracking algorithm. For example, one or more points along the boundary (431-6) may be used as derived seeds by the auto-tracking algorithm to expand the validated portion of the estimated horizon. In another example, after removing the user selected pick error (421-5), the seismic interpretation user may select a different point on the seismic trace Y (421-8) as additional seed for the auto-tracking algorithm.

Further as shown in FIG. 4.3, the screenshot 3b (432) shows the same unfolded graphical image (422-1) shown in FIG. 4.2 above with the ancestral path validated portion (431-4) and the ancestral path removed portion (431-5) stretched flat on the 2D surface. In addition, the ancestral path validated portion (431-4) and the ancestral path removed portion (431-5) may be highlighted differently to show the distinction.

In addition to viewing the ancestral path and the ancestral path seismic section shown in FIGS. 4.1, 4.2, and 4.3 above, the seismic interpretation user may define a sparse grid of in-lines and cross-lines on which the auto-picked values may be viewed and edited. As points are validated, the seismic interpretation user may elevate the status of the validated points to seeds which are then submitted back into the auto-tracking interpretation process. The increase in validated input seed points may produce a higher quality auto-tracking result for the subsequent iteration. Repeating this process at successively finer grid intervals may continue to improve the quality of, and confidence in the seismic interpretation.

FIGS. 4.4 and 4.5 demonstrate the above workflow. FIG. 4.4 shows a screenshot 4a (441) of the same seismic volume (421-1) and the same estimated horizon (421-2) shown in FIG. 4.2 above. Specifically, a coarse grid (441-5) and a fine grid (441-6) overlay the estimated horizon (421-2). The seismic interpretation user may specify the resolution of the grid to review the auto-tracked results. For example, the coarse grid (441-5) of a 20 by 20 resolution may be used that includes the grid line X (441-3) along the X direction and the grid line Y (441-4) along the Y direction. In particular, the grid line X (441-3) and the grid line Y (441-4) follow the contour of the estimated horizon (421-2) and exhibit the curvature of the estimated horizon (421-2). The seismic trace Z (441-1) and seismic trace W (441-2) intersect the grid line X (441-3) as indicated by the X marks.

FIG. 4.4 further shows a screenshot 4b (442) of a seismic section intersecting the estimated horizon (421-2) along the grid line X (441-3). The seismic interpretation user may inspect the auto-tracked results by viewing the 3D perspective view of the screenshot 4a (441) or the 2D view of the screenshot 4b (442). For example, the seismic trace Z (441-1), seismic trace W (441-2), and the grid line X (441-3) may also be inspected on the screenshot 4b (442).

FIG. 4.5 shows a screenshot 5a (451) of the same seismic volume (421-1) and the same coarse grid (441-5) shown in FIG. 4.4 above. In contrast to the estimated horizon (421-2) fully displayed in FIG. 4.4, the seismic amplitudes are displayed along points on the coarse grid (441-5) in the screenshot 5a (451). For example, each grid line of the coarse grid (441-5) has a finite width (451-2) to define a limited area on the estimated horizon (421-2) along the grid lines. This allows the seismic interpreter user to focus on evaluating validity of the auto-tracking results in this limited area on the estimated horizon (421-2). For example, the seismic interpreter user may specify an error (e.g., user selected pick error (451-1)) of the auto-tracked results by concentrating in this limited area. FIG. 4.5 also shows a screenshot 5b (452) that is basically the same as the screenshot 4b (442) with the addition of the user selected pick error (451-1) separating the gird line X (441-3) into the validated portion (452-2) and the removed portion (452-3). The seismic interpreter user may specify the user selected pick error (451-1) when viewing the 3D perspective view of the screenshot 5a (451) or the 2D view of the screenshot 5b (452).

Once the seismic interpreter user completes the review of the seismic section intersecting the estimated horizon (421-2) along the grid line X (441-3), another seismic section intersecting the estimated horizon (421-2) along the grid line Y (441-4) may be displayed for review. In addition, other seismic sections intersecting the estimated horizon (421-2) along the remaining grid lines (either X direction or Y direction) of the coarse grid (441-5) may also be displayed for review. For example, the seismic interpreter user may select any seismic section in any order for review. Once the review based on the coarse grid (441-5) is completed, the estimated horizon (421-2) is revised to retain the validated portion of each grid line of the coarse grid (441-5) exclusively. In other words, the removed portions of grid lines of the coarse grid (441-5), as well as any points not included on the coarse grid (441-5) are removed from the estimated horizon (421-2). The validated portions of the grid lines of the coarse grid (441-5) are then used as seeds to perform another iteration of the auto-tracking process to generate a revised estimated horizon.

The workflow described above may be repeated based on the revised estimated horizon using a finer grid resolution, such as the resolution of the fine grid (441-6) shown in FIG. 4.4 above.

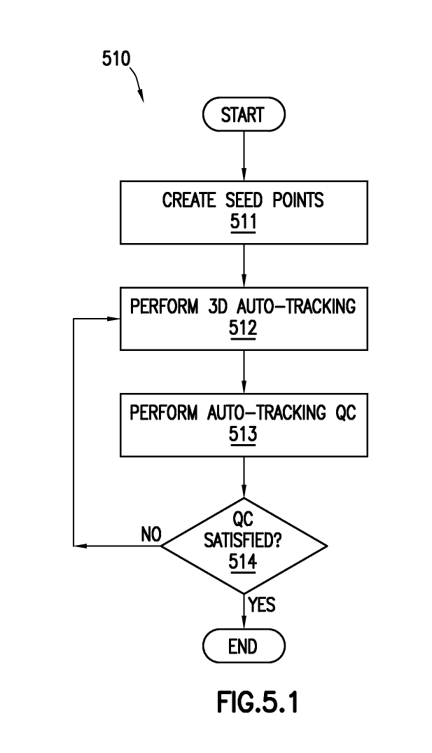

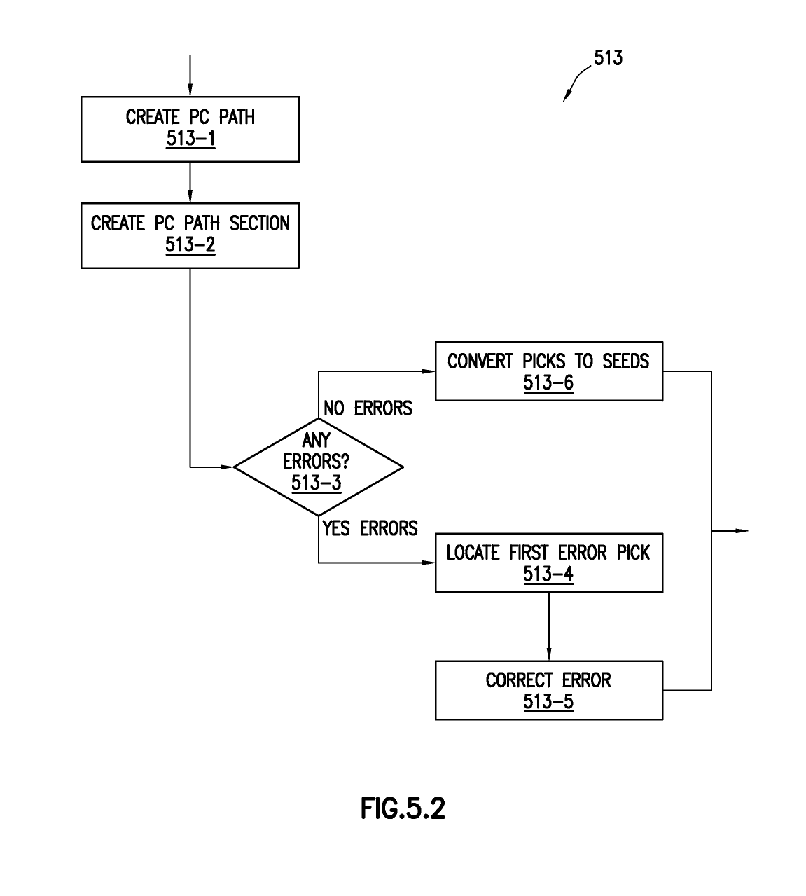

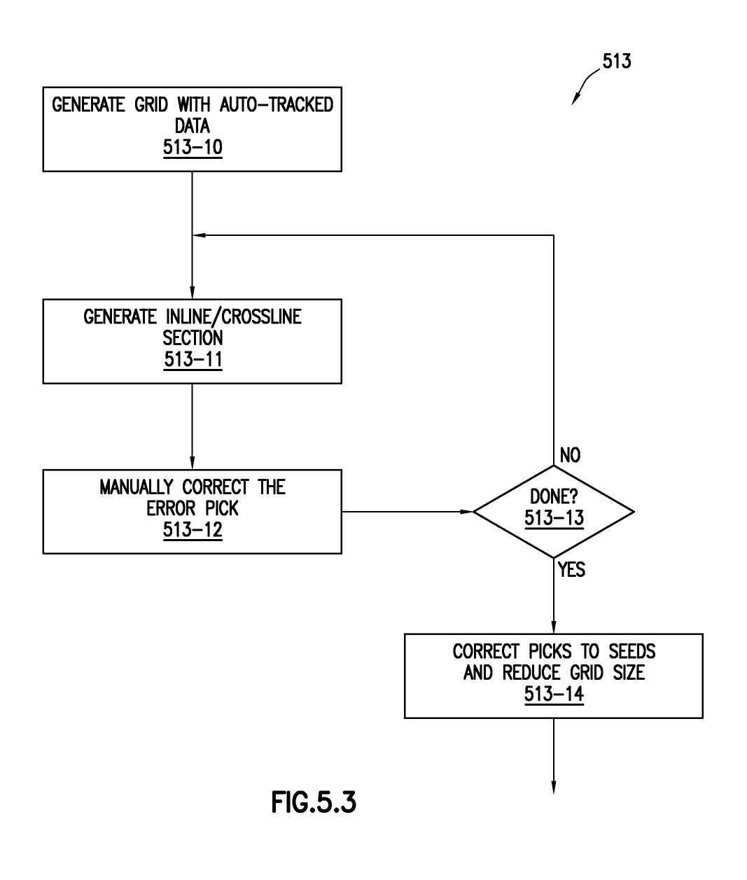

FIGS. 5.1, 5.2, and 5.3 show example workflows for quality control of 3D horizon auto-tracking in seismic volume in accordance with one or more embodiments.

FIG. 5.1 shows a workflow (510) for quality control of 3D horizon auto-tracking results. As shown in the workflow (510), seed points are created (Block 511) to perform the 3D auto-tracking (Block 512). Iteratively, auto-tracking QC (Block 513) is performed to QC the auto-picked data. If QC is not satisfied, the 3D auto-tracking (Block 512) is iterative adjusted. The interpreted horizon is successfully extracted over 3D seismic volume when QC is satisfied (Block 514) from the auto-tracking QC. Details of the auto-tracking QC (Block 513) is described in reference to FIGS. 5.2 and 5.3 below.

FIG. 5.2 shows additional details of the auto-tracking QC (Block 513) using the ancestral path. As shown in FIG. 5.2, ancestral (PC) path is created (Block 513-1) and an ancestral path seismic section is generated (Block 513-2). Auto-tracked results are viewed along the ancestral path seismic section to detect any error in the auto-tracking picks (Block 513-3). Multiple ancestral path sections may be used. Edits are made (Block 513-5) if any error is found (Block 513-4) and validated points are converted to seeds (Block 513-6) for use in subsequent auto-tracking computations.

FIG. 5.3 shows additional details of the auto-tracking QC (Block 513) using the sparse grid. As shown in FIG. 5.3, sparse grid is created (Block 513-10) and seismic in-line and cross-line section located on the sparse grid is generated (Block 513-11). Auto-tracked results are viewed along the seismic section. Edits are made (Block 513-12) and when in-line and cross-line seismic sections along the sparse grid are validated (Block 513-13), points are converted to seeds (Block 513-14) for use in subsequent auto-tracking computations. For example, the grid size may be reduced for the next iteration.

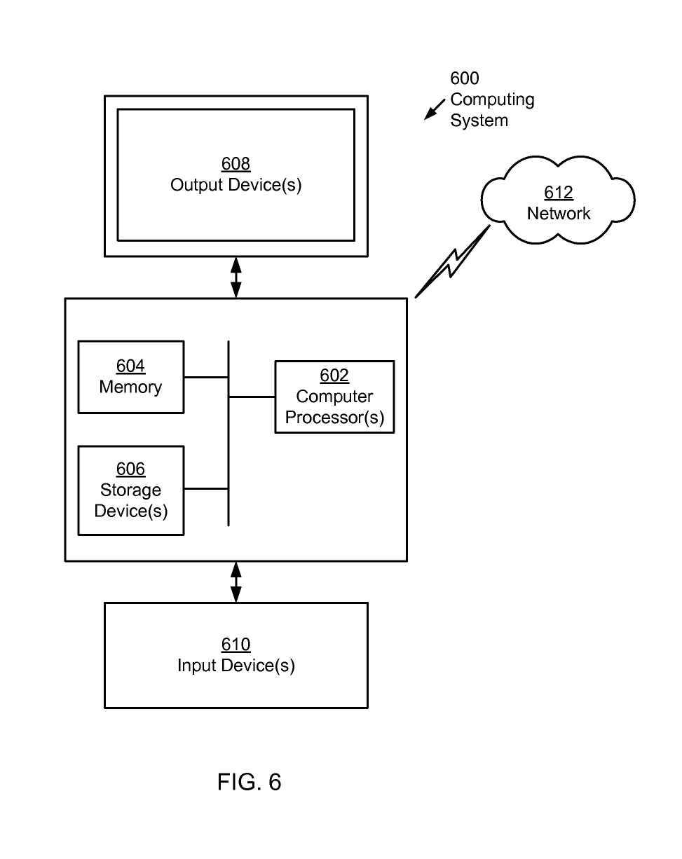

Embodiments of quality control of 3D horizon auto-tracking in seismic volume may be implemented on a computing system. Any combination of mobile, desktop, server, embedded, or other types of hardware may be used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments. For example, as shown in FIG. 6, the computing system (600) may include one or more computer processor(s) (602), associated memory (604) (e.g., random access memory (RAM), cache memory, flash memory, etc.), one or more storage device(s) (606) (e.g., a hard disk, an optical drive such as a compact disk (CD) drive or digital versatile disk (DVD) drive, a flash memory stick, etc.), and numerous other elements and functionalities. The computer processor(s) (602) may be an integrated circuit for processing instructions. For example, the computer processor(s) may be one or more cores, or micro-cores of a processor.

The computing system (600) may also include one or more input device(s) (610), such as a touchscreen, keyboard, mouse, microphone, touchpad, electronic pen, or any other type of input device. Further, the computing system (600) may include one or more output device(s) (608), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device. The computing system (600) may be connected to a network (612) (e.g., a local area network (LAN), a wide area network (WAN) such as the Internet, mobile network, or any other type of network) via a network interface connection (not shown). The input and output device(s) may be locally or remotely (e.g., via the network (612)) connected to the computer processor(s) (602), memory (604), and storage device(s) (606). Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of quality control of 3D horizon auto-tracking in seismic volume.

Further, one or more elements of the aforementioned computing system (600) may be located at a remote location and connected to the other elements over a network (612). Further, embodiments may be implemented on a distributed system having a plurality of nodes, where each portion of quality control of 3D horizon auto-tracking in seismic volume may be located on a different node within the distributed system. In one embodiment of quality control of 3D horizon auto-tracking in seismic volume, the node corresponds to a distinct computing device. The node may correspond to a computer processor with associated physical memory. The node may correspond to a computer processor or micro-core of a computer processor with shared memory and/or resources.

The systems and methods provided relate to the acquisition of hydrocarbons from an oilfield. It will be appreciated that the same systems and methods may be used for performing subsurface operations, such as mining, water retrieval, and acquisition of other underground fluids or other geomaterials from other fields. Further, portions of the systems and methods may be implemented as software, hardware, firmware, or combinations thereof.

While quality control of 3D horizon auto-tracking in seismic volume has been described with respect to a limited number of embodiments, those skilled in the art, having benefit of this disclosure, will appreciate that other embodiments can be devised which do not depart from the scope as disclosed herein. Accordingly, the scope is as described by the attached claims.

What is claimed is:

1. A method for seismic interpretation, comprising:
obtaining a seismic volume of a subterranean formation of a field, wherein the seismic volume comprises a set of seismic traces of the subterranean formation;
generating, through the seismic volume based on a similarity criterion of seismic values in the set of seismic traces, an estimated horizon based on a selected seed while maintaining tracking data tracking the generating of the estimated horizon;
receiving a first selection of a selected point in the estimated horizon;
extracting, from the tracking data, an ancestral path from the selected point to the selected seed, wherein the ancestral path comprises a sequence of derived points that are recursively derived from the selected seed based on the similarity criterion;
selecting a subset of the set of seismic traces based on the subset comprising points along the ancestral path; and
displaying, within a graphic window on a physical display, the subset of the set of seismic traces, wherein the subset of the set of seismic traces is annotated with the ancestral path.

2. The method of claim 1, further comprising:
receiving, in response to the displaying, an adjustment of the estimated horizon to generate a revised estimated horizon; and
performing a field operation based on the revised estimated horizon.

3. The method of claim 2, wherein the displaying comprises:
converting a folded graphical image formed by the subset of the set of seismic traces into an unfolded graphical image on a two-dimensional surface;
annotating the unfolded graphical image with the ancestral path; and
displaying the unfolded graphical image annotated with the ancestral path within the graphic window on the physical display.

4. The method of claim 3, further comprising:
receiving, in response to displaying the unfolded graphical image annotated with the ancestral path, a second selection identifying a derived point from the sequence of derived points as an error of the estimated horizon,
wherein the adjustment specifies removing a portion of the ancestral path downstream to the derived point in an opposite direction from the selected seed.

5. The method of claim 4, further comprising:
generating a validated portion of the estimated horizon by at least:
removing, from the estimated horizon, the portion of the ancestral path; and
further removing, from the estimated horizon and based on the tracking data, a portion of the estimated horizon that is derived from the portion of the ancestral path; and
expanding the validated portion of the estimated horizon into the revised estimated horizon based on the similarity criterion of seismic values in the set of seismic traces.

6. The method of claim 1, further comprising:
generating a first grid that superimposes the estimated horizon;
presenting, within the graphic window on a physical display and to a user, a first portion of the set of seismic traces that intersect a first grid line of the first grid, wherein the first portion of the set of seismic traces is annotated with the first grid line; and
receiving, from the user and in response to presenting the first portion, a first adjustment of the estimated horizon to generate a revised estimated horizon.

7. The method of claim 6, further comprising:
combining the first grid and at least the adjustment to generate a validated portion of the estimated horizon, wherein a remainder portion of the estimated horizon separate from the validated portion is removed from the estimated horizon; and
expanding the validated portion of the estimated horizon into the revised estimated horizon based on the pre-determined auto-tracking algorithm.

8. The method of claim 7,
annotating, with the first grid line, a graphical image formed by the first portion of the set of seismic traces; and
displaying the graphical image annotated with the first grid line within the graphic window on the physical display,
wherein the adjustment specifies a change of the first grid line within the graphical image.

9. The method of claim 6, further comprising:
generating a second grid that superimposes the revised estimated horizon, wherein at least a portion of the second grid is based on a finer scale than the first grid;
presenting, within the graphic window and to the user, a second portion of the set of seismic traces that intersect a second grid line of the second grid, wherein the second portion of the set of seismic traces is annotated with the second grid line; and
receiving, from the user and in response to presenting the second portion, a second adjustment of the revised estimated horizon to generate a further revised estimated horizon,
wherein the field operation is performed further based on the further revised estimated horizon.

10. A system for seismic interpretation, comprising:
a plurality of data acquisition tools disposed in the field and configured to obtain a seismic volume comprising a set of seismic traces of a subterranean formation of the field;
a three dimensional (3D) auto-tracking tool executing on a computer processor and configured to perform seismic interpretation of the subterranean formation, the 3D auto-tracking tool comprising:
a 3D auto-tracking module configured to:
generate, through the seismic volume based on a similarity criterion of seismic values in the set of seismic traces, an estimated horizon based on a selected seed while maintaining tracking data tracking
the generating of the estimated horizon, and an auto-tracking quality control module configured to:
extract, from the tracking data, an ancestral path from the selected point to the selected seed, wherein the ancestral path comprises a sequence of derived points that are recursively derived from the first selected seed based on the similarity criterion,
select a subset of the set of seismic traces based on the subset comprising points along the ancestral path, and
display, within a graphic window on a physical display, the subset of the set of seismic traces, wherein the subset of the set of seismic traces is annotated with the ancestral path; and
a data repository coupled to the computer processor and configured to store the seismic volume, the tracking data, and the estimated horizon.

11. The system of claim 10,
wherein the auto-tracking quality control module is further configured to receive, in response to the displaying, an adjustment of the estimated horizon to generate a revised estimated horizon, and
wherein the system further comprises a field task engine coupled to the computer processor and configured to perform the field operation based on the revised estimated horizon.

12. The system of claim 11, wherein the displaying comprises:
converting a folded graphical image formed by the subset of the set of seismic traces into an unfolded graphical image on a two-dimensional surface;
annotating the unfolded graphical image with the ancestral path; and
displaying the unfolded graphical image annotated with the ancestral path within the graphic window on the physical display.

13. The system of claim 12, wherein the auto-tracking quality control module is further configured to:
receive, in response to displaying the unfolded graphical image annotated with the ancestral path, a second selection identifying a derived point from the sequence of derived points as an error of the estimated horizon,
wherein the adjustment specifies removing a portion of the ancestral path downstream to the derived point in an opposite direction from the selected seed.

14. The system of claim 13,
wherein the auto-tracking quality control module is further configured to generate a validated portion of the estimated horizon by at least:
removing, from the estimated horizon, the portion of the ancestral path; and
further removing, from the estimated horizon and based on the tracking data, a portion of the estimated horizon that is derived from the portion of the ancestral path, and
wherein the 3D auto-tracking module is further configured to expand the validated portion of the estimated horizon into the revised estimated horizon based on the similarity criterion of seismic values in the set of seismic traces.

15. A non-transitory computer readable storage medium storing instructions for seismic interpretation, the instructions when executed causing a processor to:
obtain a seismic volume of a subterranean formation of a field, wherein the seismic volume comprises a set of seismic traces of the subterranean formation;
generate, through the seismic volume based on a similarity criterion of seismic values in the set of seismic traces, an estimated horizon based on a selected seed while maintaining tracking data tracking the generating of the estimated horizon;
receive a first selection of a selected point in the estimated horizon;
extract, from the tracking data, an ancestral path from the selected point to the selected seed, wherein the ancestral path comprises a sequence of derived points that are recursively derived from the selected seed based on the similarity criterion;
select a subset of the set of seismic traces based on the subset comprising points along the ancestral path; and
display, within a graphic window on a physical display, the subset of the set of seismic traces, wherein the subset of the set of seismic traces is annotated with the ancestral path.

16. The non-transitory computer readable storage medium of claim 15, the instructions when executed further causing a processor to:
receive, in response to the displaying, an adjustment of the estimated horizon to generate a revised estimated horizon.

17. The non-transitory computer readable storage medium of claim 16, wherein the displaying comprises:
converting a folded graphical image formed by the subset of the set of seismic traces into an unfolded graphical image on a two-dimensional surface;
annotating the unfolded graphical image with the ancestral path; and
displaying the unfolded graphical image annotated with the ancestral path within the graphic window on the physical display.

18. The non-transitory computer readable storage medium of claim 17, the instructions when executed further causing a processor to:
receive, in response to displaying the unfolded graphical image annotated with the ancestral path, a second selection identifying a derived point from the sequence of derived points as an error of the estimated horizon,
wherein the adjustment specifies removing a portion of the ancestral path downstream to the derived point in an opposite direction from the selected seed.

19. The non-transitory computer readable storage medium of claim 18, the instructions when executed further causing a processor to:
generate a validated portion of the estimated horizon by at least:
removing, from the estimated horizon, the portion of the ancestral path; and
further removing, from the estimated horizon and based on the tracking data, a portion of the estimated horizon that is derived from the portion of the ancestral path; and
expand the validated portion of the estimated horizon into the revised estimated horizon based on the similarity criterion of seismic values in the set of seismic traces.

20. The non-transitory computer readable storage medium of claim 15, the instructions when executed further causing a processor to:
perform a field operation based on the revised estimated horizon.
